(19) United States
(12) Patent Application Publication
(10) Pub. No.: US 2006/0101382 A1
(43) Pub. Date: May 11, 2006

(54) System for and method of litigation management and support

(76) Inventor: Robert Jeffries, Virginia Beach, VA (US)

Correspondence Address: ROZSA LAW GROUP LC, 15910 VENTURA BOULEVARD, SUITE 1601, ENCINO, CA, 91436-2815, US

(21) Appl. No.: 10/983,109

(22) Filed: Nov. 4, 2004

(51) Int. Cl. G06F 9/44

(52) U.S. Cl. 717/104

(57) ABSTRACT

A system for and method of litigation management and support for providing logical analysis of the critical problem of proving a legal case at trial, including the computer hardware for and software program steps of: (1) specifying the claims or defenses at issue; (2) specifying the elements of the particular claim or defense; (3) identifying what evidence is in hand; (4) identifying what evidence must still be secured; (5) estimating how much will it cost to secure the evidence; (6) estimating the strength of the evidence; (7) estimating the strength of the desired inferences from the evidence; (8) identifying what rules of law affect the proof; (9) estimating the likely resolution of disputed points of law; and (10) specifying the logical relationships among the elements of the claim or defense, the evidence and the rules of law.

### BACKGROUND OF THE INVENTION

1. Field of the Invention

The present invention relates generally to the field of computer hardware technologies and software programs, and more particularly, to the field of system for and method of providing computer-aided litigation management and support.

2. Description of the Prior Art

Litigation is perhaps the most stressful specialty within the legal profession. One reason for the high level of stress is that a litigator often has enormous responsibilities of all aspects of litigation but without an effective way of controlling and managing the various tasks, information, evidence and witnesses associated with a litigation. A host of unpredictable contingencies from the identity of the judge to the shifting loyalties of essential witnesses randomly influence the process. The facts and legal principles of a case, and a constantly evolving to-do list, swirl around in the litigator's head like leaves in a storm. There is a constant fear that something may have been missed or forgotten.

With the development of computer hardware and software technologies, it is now possible to provide a system and method as a valuable tool to help a litigator to manage a litigation by introducing order and discipline into the process of collecting evidence and preparing to present the evidence.

There have been various approaches in this field, as shown in the following references:
1. U.S. Pat. No. 5,159,180 issued to Feiler on Oct. 27, 1992 for “Litigation Support System and Method” (hereafter the “Feiler patent”);
2. U.S. Pat. No. 5,557,515 issued to Abbruzzese on Sep. 17, 1996 for “Computerized System and Method for Work Management” (hereafter the “Abbruzzese patent”);
3. U.S. Pat. No. 5,838,966 issued to Harlan on Nov. 17, 1998 for “Computer-Aided Litigation Control System” (hereafter the “Harlan patent”);
4. U.S. Pat. No. 5,940,800 issued to Bennett on Aug. 17, 1999 for “Attorney Terminal Having Outline Preparation Capabilities for Managing Trial Proceedings” (hereafter the “Bennett patent”);
5. U.S. Pat. No. 5,956,687 issued to Wamsley on Sep. 21, 1999 for “Personal Injury Claim Management System” (hereafter the “Wamsley patent”);
6. U.S. Pat. No. 6,098,070 issued to Maxwell on Aug. 1, 2000 for “Case Management for A Personal Injury Plaintiff's Law Office Using A Relational Database” (hereafter the “Maxwell patent”);
7. U.S. Pat. No. 6,125,340 issued to Miles on Sep. 26, 2000 for “System for Determining the Probability that Items of Evidence Prove A Conclusion” (hereafter the “Miles patent”);
8. U.S. Pat. No. 6,128,620 issued to Pissanos on Oct. 3, 2000 for “Medical Database for Litigation” (hereafter the “Pissanos patent”);
9. U.S. Pat. No. 6,226,620 B1 issued to Oon on May 1, 2001 for Iterative Problem Solving Technique” (hereafter the “Oon patent”);
10. U.S. Pat. No. 6,298,327 B1 issued to Hunter on Oct. 2, 2001 for “Expert Support System for Authoring Invention Disclosures” (hereafter the “Hunter patent”);
11. U.S. Pat. No. 6,336,096 B1 issued to Jemberg on Jan. 1, 2002 for “System and Method for Evaluating Liability” (hereafter the “Jernberg patent”); and
12. PCT Patent Publication No. WO 97/41524 by Jones Steven and published on Nov. 6, 1997 for “Legal Claims Processing System and Methods of Litigation Management Using the Same “(hereafter the “Steven Publication”).

The Feiler patent discloses a litigation support system and method in which information regarding documents and other items of evidence are stored in record fields of an electronic database using an optical scanning mechanism with the ability to scan bar-codes or other indicia. The database is relational and includes six (6) separate topical databases: “document database”, the “people database”, the “comment database”, the “deposition database”, the “witness database” and the “trial database”. The method uses a bar-code to generate a single relation among databases, and also uses bar-code authority lists for entries into the disclosed litigation support computer system, to improve both the speed of coding documents or other items of evidence as well as the accuracy of such coding.

The Abbruzzese patent discloses a computerized system and method for managing work in process. Case specific information, including information from an initial transaction, is electronically entered into a database and automatically linked with a work source index which includes basic client information. Input information residing in externally generated documents is scanned into the system as images for subsequent display or conversion to textual data. As work is performed on the case, the system tracks its progress and provides a variety of support functions. An electronic activity log function maintains a record of key activities involved in the processing of work items. The system can be used by attorneys to track their billing hours.

The Harlan patent discloses a computer-aided litigation control system where data generated and accumulated during a litigation is organized in a matrix of screens according to Section (category) and Level for later retrieval. Each screen is accessed by user selection of a point on the matrix and each screen has a pattern of fields at which data can be entered into the system. By imposing a pattern of fields of data entry, codes can be associated with each entry which permit ease of retrieval. Different subsets of the set of fields in the various screens have like codes to encode data entered there and to retrieve their subsets of stored data entered at other fields and having like codes. A data file is established for each case and a matrix is operative in a manner analogous to a template where a field is like an aperture in the template permitting access only to the data at the aperture.

The Bennett patent discloses a system which provides an outline for storing, associating and managing case evidence, case law and work product for a given lawsuit at issue. Accessed through attorney terminals, the outline is structured based on a hierarchical categorization of the lawsuit into the law and fact at issue. Associated with each categorization entry in the hierarchical outline are groupings of case law, case evidence, relevance and draft discovery information for rapid access by the attorney. Each categorization entry in the tailored outline provides instant access to case law via headnotes, treatise selections, seminal cases, and preset searches. The system also automatically tracks the use of exhibits in a proceeding, generates draft portions of a pretrial order including jury instructions, and generates time-lines for analysis and use during a proceeding. Draft interrogatories, document requests and deposition or trial questions are also provided.

The Wamsley patent discloses a method for computerized management of a plaintiff's personal injury case. The method includes establishing records, each reflective of the phase of a corresponding personal injury claim. The first phase corresponds to pre-negotiation of the claim and includes at least a first and second subordinate pre-negotiation stage. Each of these stages includes the generation of a number of prompts directed to obtaining information about the claim. A given record may also be set to a second management phase corresponding to negotiation of the claim or a third management phase representing settlement of the claim. In addition, the method automatically generates a demand letter and calculate settlement amounts from information gathered in the record during pursuit of the claim. The management system may include scheduling various prompts and correspondence with the program in accordance with a predetermined schedule spanning several days.

The Maxwell patent discloses an electronic case manager for a personal injury plaintiff's law office in which client and defendant level data related to an injury incident are collected and organized in an efficient manner. The electronic case manager include a relational database having a number of tables, and a database management program.

The Miles patent discloses a software program for determining whether items of evidence prove a conclusion based upon user input data. The software interrogates a user to receive characteristic information about the user and for information about the items of evidence in a trial. A user can input a probability for each item of evidence that the item of evidence is true and a probability that the item of evidence proves a conclusion. The software then calculates the probability that each item of evidence individually proves the conclusion and the probability that all of the items of evidence combined prove the conclusion. The software then performs statistical analysis of the data receive from several users to determine trends about the evidence and to model a jury or to select a jury from a pool of potential jurors.

The Pissanos patent discloses a medical database and associated methods for compiling information in a medical malpractice situation. A general medical database is provided and specific medical information corresponding to a given situation is entered. Entry of the information automatically cross-references some terms of the entered data to definitions in the general medical database. Terms are readily looked up when reviewing specific medical information and definitions are easily inserted where desired. A drug reference display provides two-way lookup from drugs to their side effects (or contraindications or interactions) and back. Significant information from an entered medical chronology is easily copied to a significant information section when a reviewer finds the information important.

The Oon patent discloses a method of implementing non-numerical spread sheets for the medical and legal domains using a computer-assisted iterative problem solving technique which starts from initial non-numerical data and develops possible solutions within a framework of an interrelationship among pre-selected non-numerical data which are divided into a plurality of mutually exclusive categories differentiated according to readiness for decision making, including the steps of: displaying on a video display, a work sheet having a plurality of cells each corresponding to one of the mutually exclusive categories for displaying the non-numerical data; entering initial non-numerical data into respective cells in the work sheet; selecting a query designating at least a first cell in the work sheet with the initial non-numerical data as an input and requesting related non-numerical data for at least one cell of the plurality of cells in the work sheet; identifying non-numerical data for the at least one cell that is related to non-numerical data in the first cell; and inserting the identified non-numerical data into at least one cell in the work sheet as further information for consideration in developing possible solutions.

The Hunter patent discloses a computer-implemented expert support system for authoring invention disclosures and for evaluating the probable patentability and marketability of a disclosed invention. The system comprises at least a computer, an input device, an output device, and a software program. The software program is developed with an object-oriented design process. The system facilitates communication of invention characteristics and enables output of invention disclosures in a plurality of formats, including that of a patent application.

The Jernberg patent discloses a system and method of evaluating liability among multiple potential responsible parties (PRPs), their insurers and multiple environmental sites. The method supports mediating and arranging settlements in toxic site cleanup between PRPs and insurers, and in appropriate cases, settlements of one or more underlying environmental claims. The system eliminates fragmentation in effecting settlements and handles the interdependence among the parties. In the method, data is gathered, relationships among the data are calculated, a coverage law adjustment factor is applied to the data, allocation and choice of law principles are applied, groupings among the multiple parties and sites are identified based on the apparent settlement potential as identified through the system's various relationships, and a qualitative decision pertaining to the likelihood of outcome is proposed to the parties within the identified groupings.

The Steven Publication disclosed an integrated and automated system for use in caseload management. The system includes a central hub having an authorized subscriber database, a router, and a selector. Each authorized subscriber is linked to the central hub via a subscriber system. The subscriber system includes a workstation at which information may be displayed and entered and a data storage medium having a new cases database, a communications management database, and a billing database. Each source or insurer is connected to the central hub via a source system. The source system includes a workstation at which information may be displayed and entered and a data storage medium having a new claims database, a communication management database, and billing database. New claims are submitted by the source and undergo a new claims authorization process carried out by the disclosed system. The claims authorization process involves the selection of a subscriber and an option conflict check process and a budget approval process. After a new case is authorized, a communication link is established through the central hub between the source where the claim originated and the selected and authorized subscriber. The system also provides processes for requesting approval in connection with certain activities for cost-containment purposes.

While various approaches of trying to address the tremendous complicities involved in litigation process have been developed, there remains a need of a more comprehensive and focused method and program that not only provide computer-aided management of the administrative and clerical aspects of a litigation but also a critical support in the substantive areas of specifying and identifying the issues, evidence, and rules of law involved in the litigation and their logical relationship to assist the legal analysis and problem solving process in order to prove a party's case at the ultimate trial.

### SUMMARY OF THE INVENTION

The present invention is directed to a new and unique system for and method of litigation management and support.

It is therefore a primary object of the present invention to provide a system for and method of litigation management and support that provide logical analysis of the critical problem of proving a legal case at trial.

It is particularly an object of the present invention to provide a system for and method of litigation management and support in the area of specifying the claims or defenses at issue in the legal case.

It is also a particular object of the present invention to provide a system for and method of litigation management and support in the area of specifying the elements of the particular claim or defense in the legal case.

It is another particular object of the present invention to provide a system for and method of litigation management and support in the area of identifying what evidence is in hand in the legal case.

It is still a particular object of the present invention to provide a system for and method of litigation management and support in the area of identifying what evidence must still be secured in the legal case.

It is still a particular object of the present invention to provide a system for and method of litigation management and support in the area of estimating how much will it cost to secure the evidence in the legal case.

It is still a particular object of the present invention to provide a system for and method of litigation management and support in the area of estimating the strength of the evidence in the legal case.

It is still a particular object of the present invention to provide a system for and method of litigation management and support in the area of estimating the strength of the desired inferences from the evidence in the legal case.

It is still a particular object of the present invention to provide a system for and method of litigation management and support in the area of identifying what rules of law affect the proof in the legal case.

It is still a particular object of the present invention to provide a system for and method of litigation management and support in the area of estimating the likely resolution of disputed points of law in the legal case.

It is a further object of the present invention to provide a system for and method of litigation management and support in the area of specifying the logical relationships among the elements of the claim or defense, the evidence and the rules of law in the legal case.

The present invention is designed to streamline and organize the facts, causes of actions, and legal issues associated with litigation. The present invention allows legal professionals to easily record the development of a cause of action and view all the relevant information in a case file in a logic based tree diagram display. This will allow law offices to create a roadmap of their case that will bring together the disparate elements of litigation and arrange it in a way that best suits the needs of those people gathering evidence, research and legal analysis.

Further novel features and other objects of the present invention will become apparent from the following detailed description, discussion and the appended claims, taken in conjunction with the drawings.

### BRIEF DESCRIPTION OF THE DRAWINGS

Referring particularly to the drawings for the purpose of illustration only and not limitation, there is illustrated:

FIG. 1 is a schematic block diagram illustrating a system for implementing the method of the present invention for providing litigation management and support;

FIG. 2.1 is the first part of a flow chart diagram illustrating the logical operation of a preferred embodiment of the present invention method of litigation management and support;

FIG. 2.2 is the second part of the flow chart diagram illustrating the logical operation of the preferred embodiment of the present invention method of litigation management and support;

FIG. 2.3 is the third and last part of the flow chart diagram illustrating the logical operation of the preferred embodiment of the present invention method of litigation management and support;

FIG. 2.4 is a flow chart diagram illustrating the functioning of a built-in utility that provides the user with a list of the elements of particular claims and defenses and automatically integrates them into the tree diagram;

FIG. 3.1 is an illustrative diagram showing a screen shot during the execution of the present invention software program, demonstrating the step through which the identities of the parties to the litigation are entered;

FIG. 3.2 is an illustrative diagram showing a screen shot during the execution of the present invention software program, demonstrating the step through which the claims and defenses being asserted in the case are entered;

FIG. 3.3 is an illustrative diagram showing a screen shot during the execution of the present invention software program, demonstrating the step through which the elements of each claim and defense are entered;

FIG. 3.4 is an illustrative diagram showing a screen shot during the execution of the present invention software program, demonstrating the step through which the facts supporting each claim and defense are entered;

FIG. 3.5 is an illustrative diagram showing a screen shot during the execution of the present invention software program, demonstrating the step through which the information regarding witness testimony is entered;

FIG. 3.6 is an illustrative diagram showing a screen shot during the execution of the present invention software program, demonstrating the step through which information regarding judicial admissions obtained through discovery is entered;

FIG. 3.7 is an illustrative diagram showing a screen shot during the execution of the present invention software program, demonstrating the step through which information regarding evidentiary documents is entered;

FIG. 3.8 is an illustrative diagram showing a screen shot during the execution of the present invention software program, demonstrating the step through which information regarding photographic evidence is entered;

FIG. 3.9 is an illustrative diagram showing a screen shot during the execution of the present invention software program, demonstrating the step through which information regarding legal points is entered;

FIG. 3.10 is an illustrative diagram showing a screen shot during the execution of the present invention software program, demonstrating the step through which information regarding “to do” items is entered;

FIG. 3.11 is an illustrative diagram showing a screen shot during the execution of the present invention software program, demonstrating the step through which information regarding ideas is entered; and

FIG. 3.12 is an illustrative diagram showing a screen shot during the execution of the present invention software program, demonstrating the step through which reports are generated.

### DETAILED DESCRIPTION OF THE PREFERRED EMBODIMENTS

Although specific embodiments of the present invention will now be described with reference to the drawings, it should be understood that such embodiments are by way of example only and merely illustrative of but a small number of the many possible specific embodiments which can represent applications of the principles of the present invention. Various changes and modifications obvious to one skilled in the art to which the present invention pertains are deemed to be within the spirit, scope and contemplation of the present invention as further defined in the appended claims.

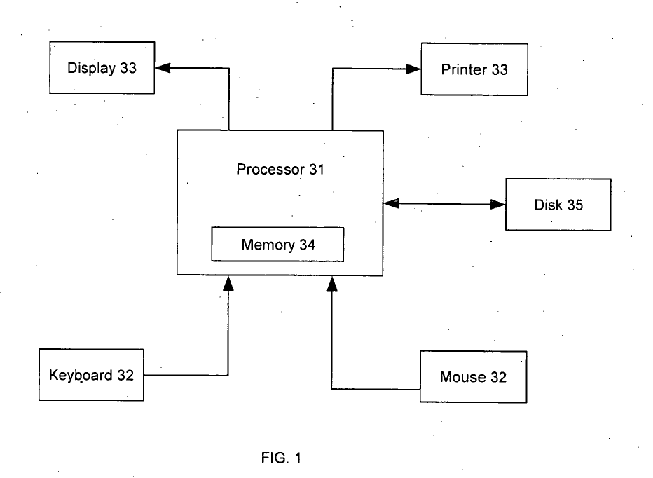

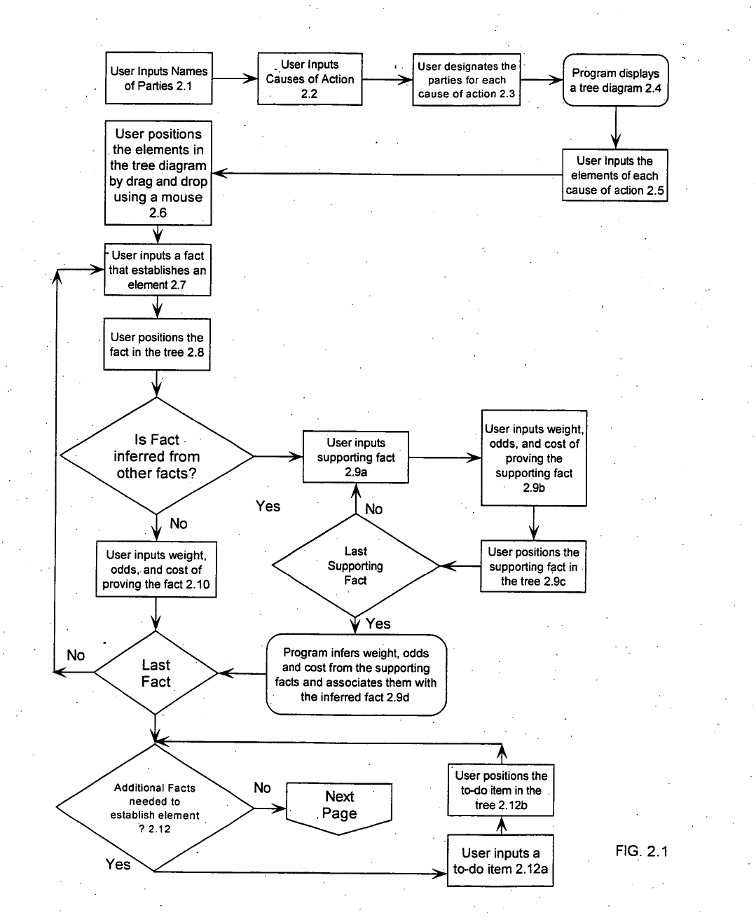

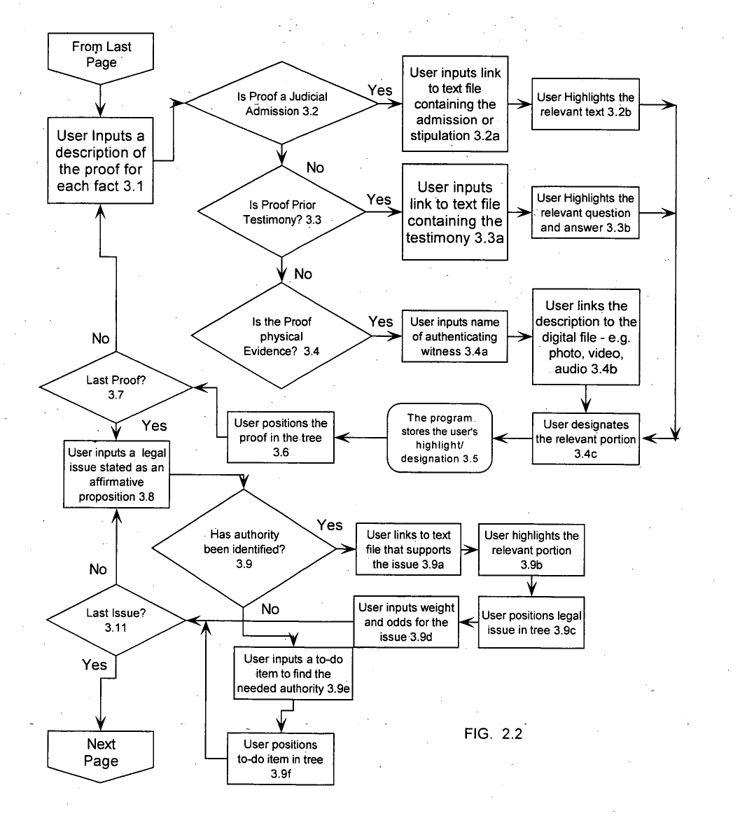

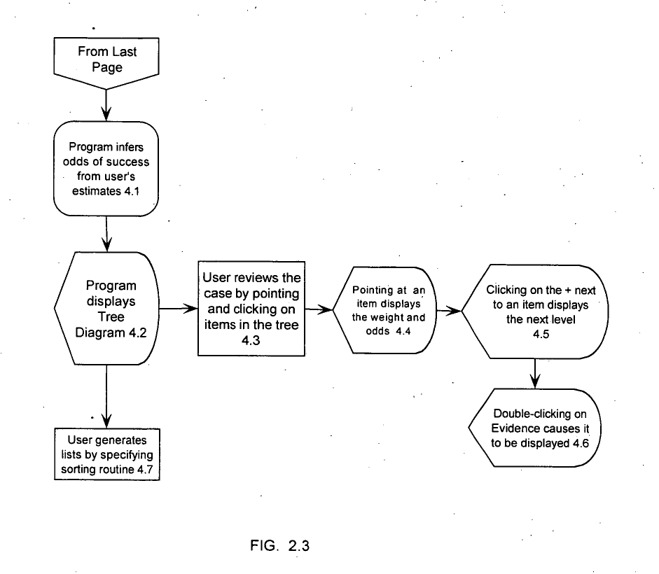

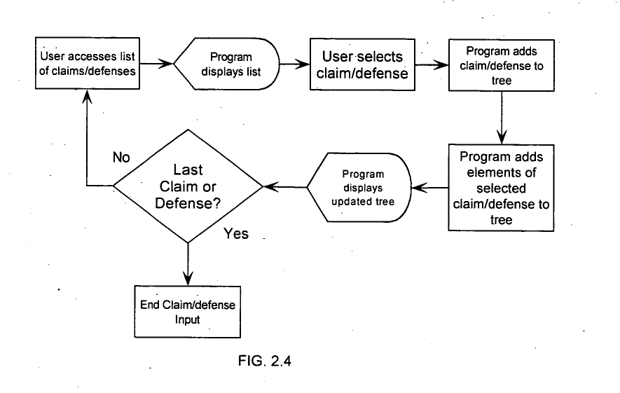

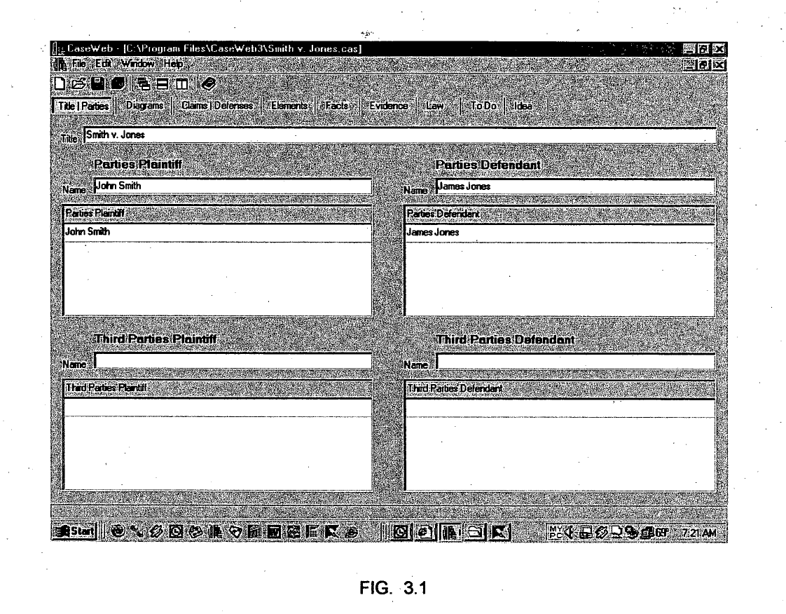

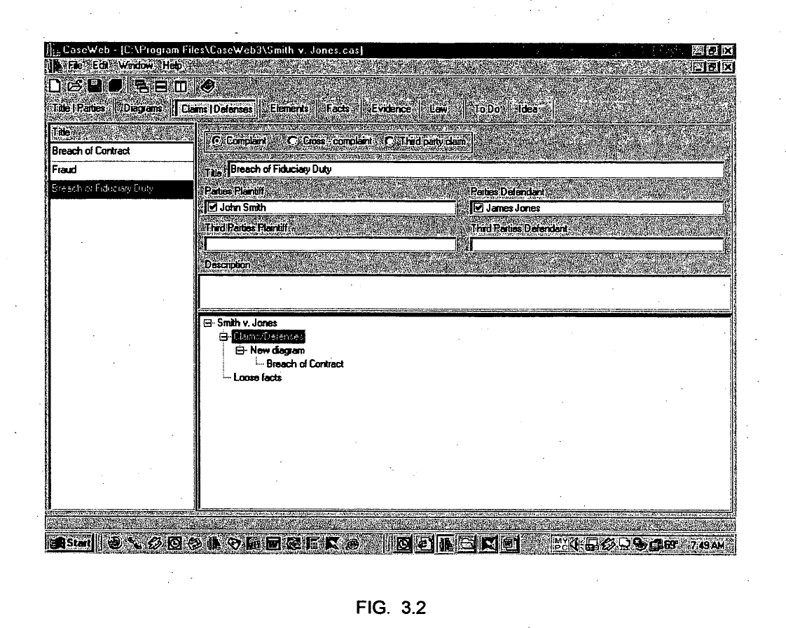

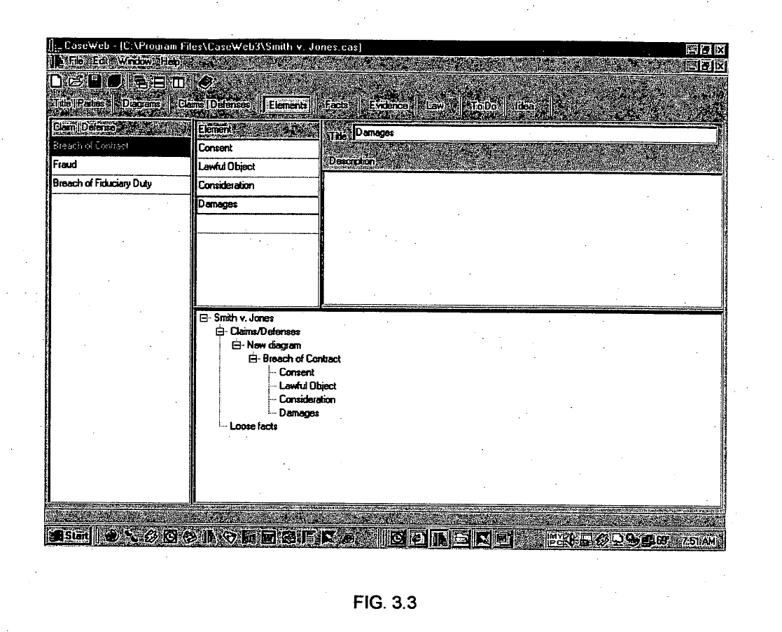

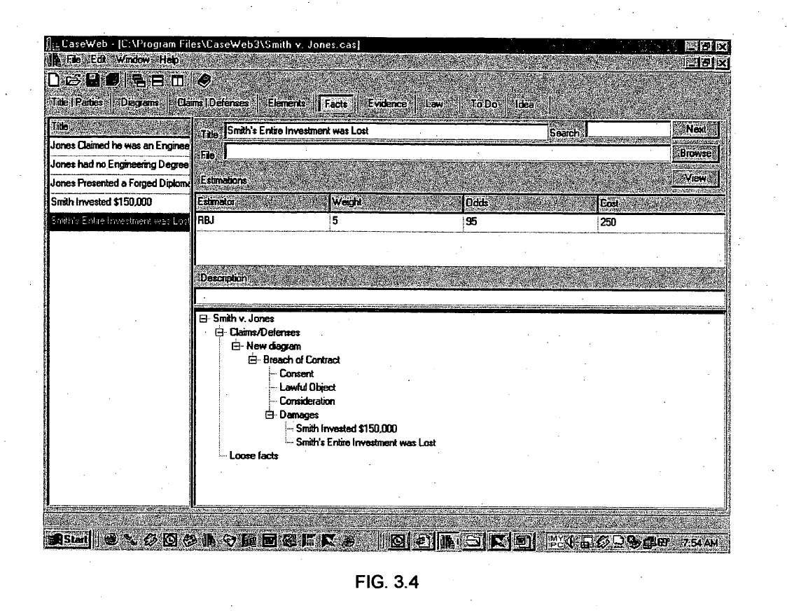

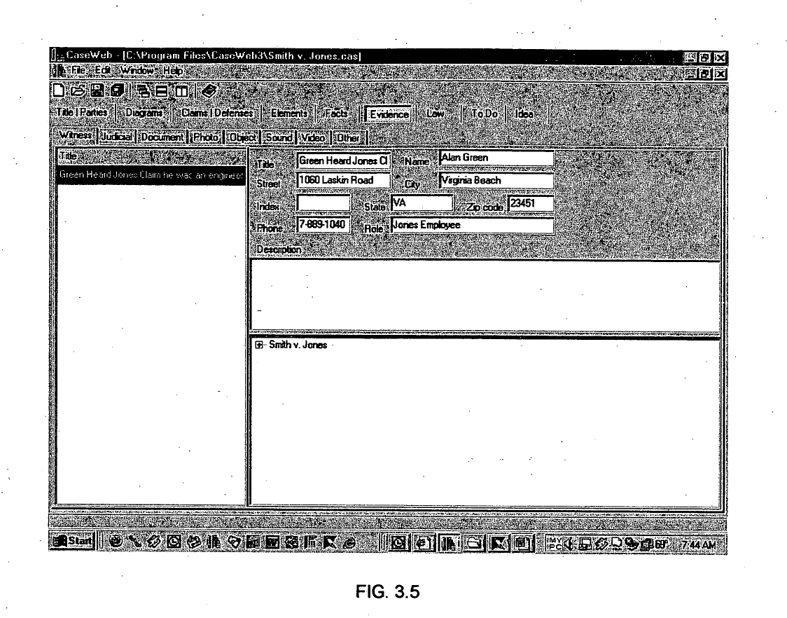

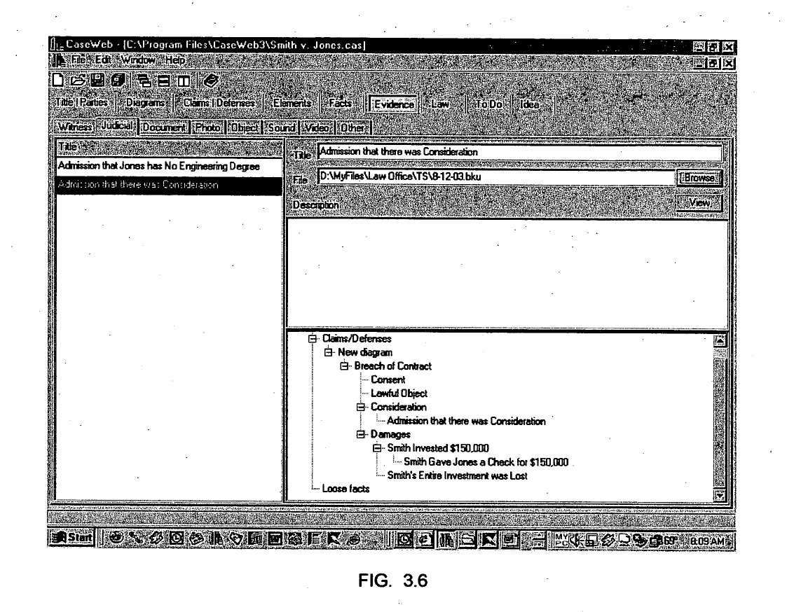

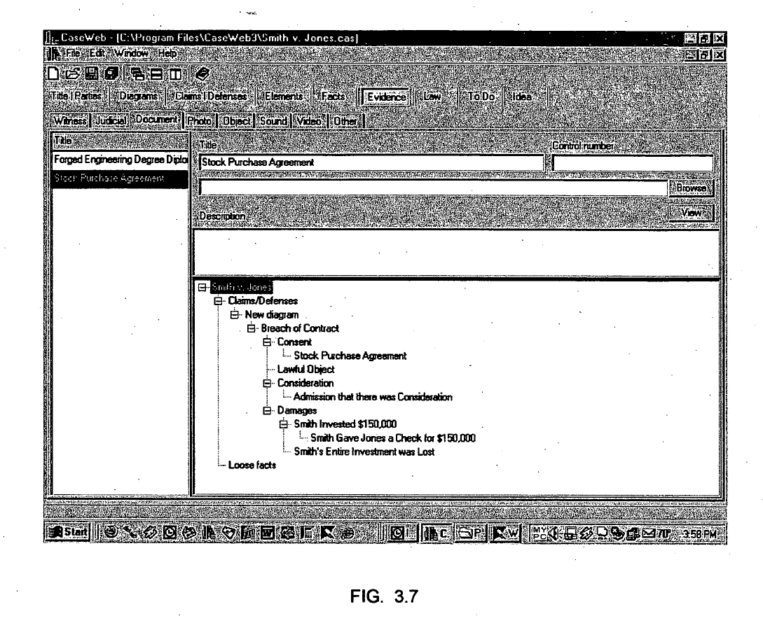

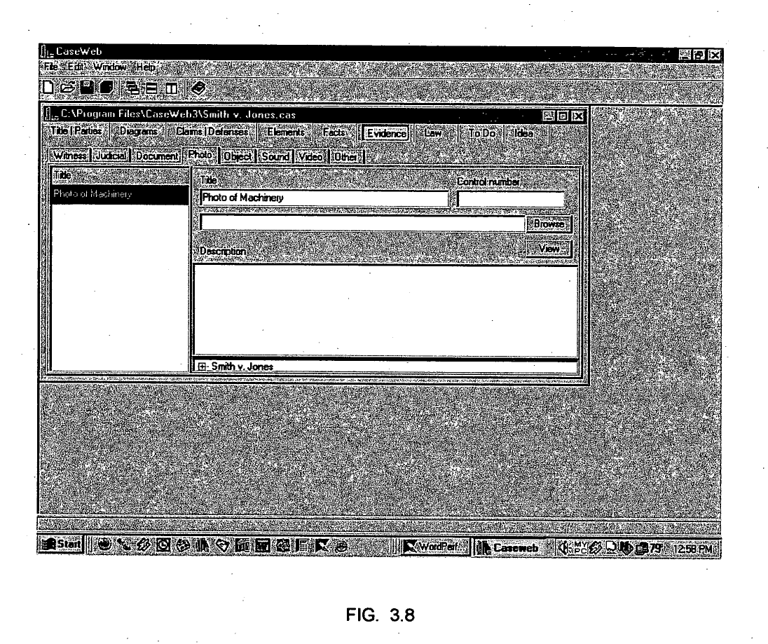

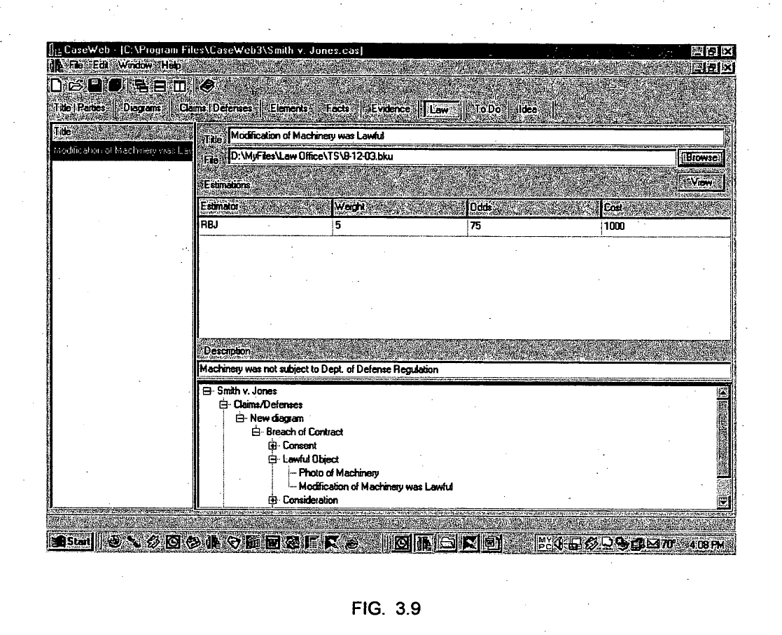

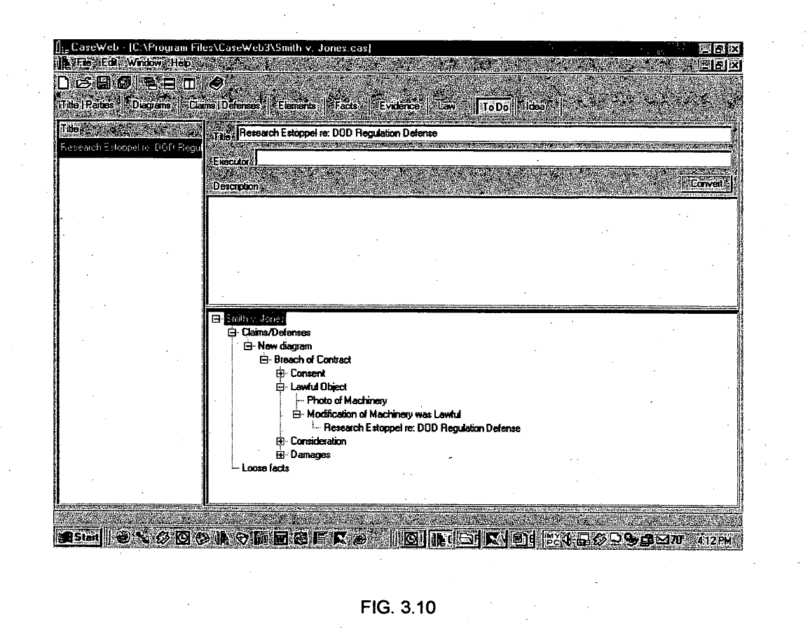

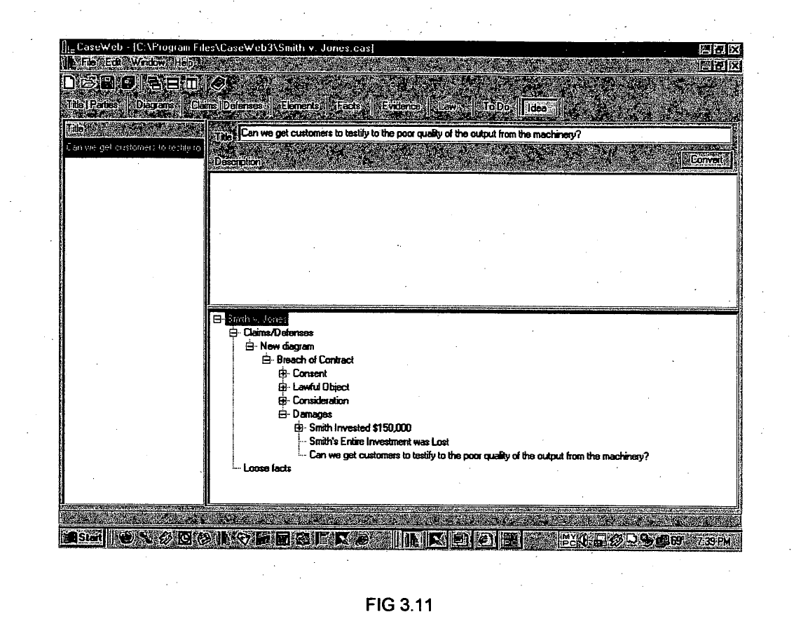

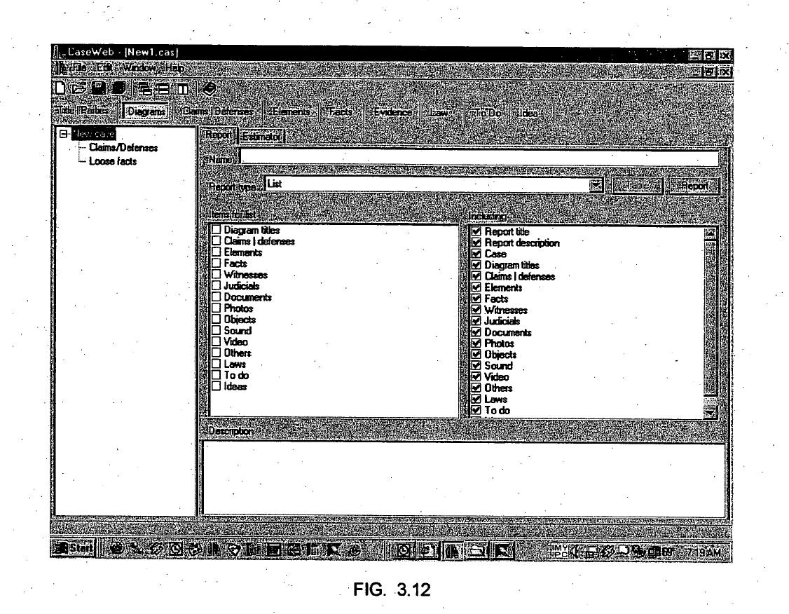

The basic arrangement of the computer system for implementing the present invention for providing litigation management and support will be first described below in conjunction with FIG. 1, followed by detailed step-by-step description of the present invention method and computer software program and algorithms in conjunction with the flow chart shown in FIGS. 2.1 through 2.3 and the screen shots shown in FIGS. 3.1 through 3.12.

Referring to FIG. 1, there is shown a schematic view of a computerized processing system 30 of one of the preferred embodiments of the present invention. System 30 includes processor 31 operatively coupled to input devices 32 and output devices 33. Processor 31 is configured to execute or perform one or more predetermined routines to process information residing in memory 34.

In the preferred embodiment of the present invention, computer system 30 is configured to execute the litigation management and support program software of the present invention.

As shown in FIG. 1, processor 31 is also configured with storage disk 35 for storing computer readable information. Input devices 32 include keyboard 37 and mouse 38, which are used to provide operator input to processor as required. Output devices 33 include visual display 40 and printer 41, which are used to provide output from routines executed by processor 31 in response to input from input devices 32. System 30 may further include other input or output devices such as a modem, network link, speaker or microphone, or such other devices as would occur to one skilled in the art.

Processor 31 may be a collection of one or more electronic components or a single custom integrated component. Processor 31 may include digital circuitry, analog circuitry, or a combination of these circuit types. Although it is preferred that the processor be readily programmable by software, it may also be programmed by firmware, configured as an integrated state machine, or employ a combination of these techniques. Preferably, processor 31 is configured to digitally receive, process, and output information in a conventional manner; however, it is envisioned that the present invention may be adapted to other types of processing techniques as would occur to those skilled in the art.

Preferably, memory 34 is of the electronic (e.g. solid state), magnetic, or optical variety that may be readily interfaced with electronic controllers or processors. Memory 34 may be integrally associated with system 30 or be remotely associated via a communication link with system 30. Disk 35 participates in system 30 as an optionally available memory accessible by processor 31.

Referring to FIGS. 2.1 through 2.3, there is shown a flowchart of the process executed according to the present invention, by which information is gathered and displayed on the screen for the user (see FIGS. 3.1 through 3.12).

The present invention program is based on a logical and sequential method for developing a case and organizing the rules of law and pieces of evidence necessary to support particular claims and defenses. A diagram is developed in which the user can see the logical relationships among the law and evidence organized under each element of each claim or defense. At several points in the process, users will assign weights, odds and costs associated with establishing relevant case facts and proving legal issues. These odds can be calculated throughout the process to give the user a derived estimate of the chances of proving any fact or position. Costs are also computed throughout the process to give the user a running cost estimate.

At the beginning of the process, a new file will be open with the names of the parties involved, and the information is entered through the screen depicted in FIG. 3.1. All information such as causes of action, evidence and legal issues will be associated with through the names of the parties.

Following the entry of the party names, the user will be prompted to enter the claims or defenses in the given case by selecting the Claims/Defenses tab. The user must input at least one cause of action to begin the diagram but the program also supports multiple causes of action. After inputting the causes of action, the user will need to assign the parties to the causes of actions. The information is entered through the screen depicted in FIG. 3.2.

At this stage the present invention program will display a tree diagram where the user can begin to develop a visual schematic of the claim or defense, the parties, and issues in the case. Once the diagram has been displayed, the user will input the elements associated with each claim or defense using the elements tab. This is done through the screen depicted in FIG. 3.3.

The user has the option of choosing from lists of the elements of generally recognized claims and defenses supplied by the program and automatically integrated into the tree diagram, as illustrated by FIG. 2.4. The list may be supplied to the user through the program itself or by download via the Internet.

The user will then associate these elements in the diagram with the cause of action. After the elements have been dropped into the diagram, each element will begin to develop its own branch on the tree diagram. This can be done in the diagram portion that appears in the lower right of all of the screens depicted in FIGS. 3.2 through 3.11.

The user can then begins the process of entering facts into the system by first selecting the fact tab from the main menu. Each fact is entered and associated with an element in the cause of action by positioning that fact in the diagram. This is done through the screen depicted in FIG. 3.4.

Depending on whether or not the fact is inferred from other facts, the user has options and variations as to how to include additional information. If the fact is inferred from other facts, the user will proceed to input supporting facts. The user will be prompted to input the weights, odds and cost of proving each supporting fact.

After inputting the supporting facts, the user will position them in the developing tree diagram under the inferred fact that is being supported. Once the last supporting fact has been entered, the program will compute the weight, odds and cost from the supporting facts and associates them with the inferred fact. This information is all entered through the screen depicted in FIG. 3.4.

If the fact entered is not inferred from other facts, then the user will proceed directly to inputting the weights, odds and costs of proving that fact. This process can be repeated for as many facts as are present to support the given element of a cause of action. Once the last known fact is entered, the user will look though the tree diagram and the status of the case. If additional facts are needed to establish an element the user can list these items.

If there is action that needs to be taken to find this additional evidence, such as gathering testimony or taking pictures the user can create a “to do” item, and then associate that “to do” item with a branch of the tree diagram. This is done through the screen depicted in FIG. 3.10. The program includes a tab that lists all the “to do” actions associated with the names of the parties in a given case. After creating a “to do” item, the user will position the item in the tree diagram where it will be associated with a fact needed to support an element.

After inputting of the facts, the user will create a description of the proof for each fact using the evidence tab. After describing the proof each fact the user will have the option of linking various types of documents to substantiate the proof given. If the proof of a fact is based on testimony, the user will select that tab from the evidence menu. Once the user has selected the testimony tab they will have the option of including a link to the file containing a transcript of the testimony, if one exists. This is entered through the screen display depicted in FIG. 3.5.

This testimony can be linked by browsing the computer and finding the associated text file. Once the file has been linked, the user can highlight the relevant portion of the testimony that provides proof of the fact.

If the proof is a judicial admission such as an admission contained in a responsive pleading or given in a discovery response, the user will select the judicial admission tab. Once the judicial admission has been described, the user then has the option to create a link to the text file containing the admission or stipulation or an image of it. The program will further allow the user to highlight relevant text in the judicial admission once the file containing that information has been uploaded. If the proof of the fact is based on physical evidence the user will select one of the tabs labeled: document, photo, object, sound, video or other, and then follow up with the names of authenticating witnesses, and expand on any further description of the physical evidence. Under the physical evidence tab the user will also have to the option of linking the digital file associated with the evidence, whether that is a text, photo, video or audio file.

As with the other evidence tabs, the user will have the option to highlight relevant portions of the physical evidence. Finally, following the highlighting of relevant portions of information, the program will store the designation and the user can begin positioning each of the proofs in the tree. This is entered through the screens depicted in FIGS. 3.6 through 3.7.

Once the user has entered the last evidentiary proof and positioned it in the tree diagram, the user will move to the legal issues tab. The user will input a new legal issue which will be expressed as an affirmative proposition. This is accomplished using the screen depicted in FIG. 3.9.

The user will then need to decide whether any authority on this issue has been identified. If the is an established source of authority on that issue, a link can be created to the text file that contains it. As with the factual proofs, the user will then be able to highlight the relevant portion of the text.

After the text has been highlighted and linked, the user can then place the issue in the proper position on the tree diagram where it will be associated with an element of the cause of action. Once the authority issue is in place, the user will be prompted to enter the weight and odds of establishing that issue.

The user will also have the opportunity to create additional “to do” items if a legal issue entered does not have an authority identified to support the position on the issue. If there is no authority, user will select the “to do” tab and create a task to find that authority.

This new “to do” item can then be placed in the tree diagram as well, displaying where there is additional work to be done on that element of the claim. Once the last issue has been entered and the associated authorities and “to do” items placed in the tree, the user will close the legal issues tab.

Once all of the information has been entered in the case concerning the parties, the cause of action, the elements of the claim, the facts and evidentiary proofs, and the legal issues, the program will infer the odds of success from user's estimates. Using the information generated by the program, the user will be able to easily examine the weaker elements of the claim and those that need additional research and investigation.

Once the final odds have been calculated the user can view the completed tree diagram, the present invention diagram will show the entire course of the claims and defenses and when fully expanded will display the links to all relevant case documents. When the entire tree is displayed the user can see the weights and odd given to any element of the case.

The user can navigate through the levels of the tree by clicking on the + sign next to any item that has sub-items. Double-clicking on items such as evidence or legal authority causes the linked file to be displayed. The user can generate lists of items by specifying the sorting criteria. This is accomplished through the screen depicted in FIG. 3.12.

The present invention method has many important advantages. It provides an effective and streamlined tool to support legal professionals in their management and handling of often complicated case tasks. It also provides a quick and visualized way to specify the claims or defenses at issue, and the elements of the particular claim or defense. It helps the legal professionals to identify what evidence is in hand, what evidence must still be secured, and what rules of law affect the proof. It provides an objective estimation of how much will it cost to secure the evidence, the strength of the evidence, the strength of the desired inferences from the evidence, and the likely resolution of disputed points of law. Moreover, it helps the legal professionals to identify and understand the logical relationships among the elements of the claim or defense, the evidence and the rules of law.

Defined in detail, the present invention is a method of providing litigation management and support by utilizing a computer system with adequate computing power and memory and data storage capacity and means for input and output, the method comprising the steps of: (a) executing a program on the computer that prompts a user to input necessary specifiable information of a case through the input means; (b) producing a visual diagram through the output means that allows the user to place the specified information at appropriate positions of the diagram, including specifying the parties in the case, the claims and defenses in the case, and the elements of the claim or defense in the case; (c) prompting and receiving identifiable information of the case related to proof of facts for the case and placing the identified information at appropriate positions of the diagram in correct correlation with the specified information, including identifying what evidence has been secured, what evidence needs to be secured, what rules of law affect the proof of the case, and what points of law are disputed; (d) computing estimations to assist the user in evaluation of the case, including an estimation on the strength of each evidence, an estimation on the strength of a desired inference from each evidence, an estimation on how much it will cost to secure needed evidence, and an estimation on a likely resolution of the disputed points of law; and (e) establishing the logical relationships among the specified information and the identified information.

Defined broadly, the present invention is a method of providing litigation management and support by utilizing a computer system with adequate computing power and memory and data storage capacity and means for input and output, the method comprising the steps of: (a) executing a program on the computer that prompts a user to input necessary specifiable information of a case through the input means, including the parties to the case, the claims and defenses, and the elements of each claim and defense; (b) producing a visual “tree” diagram through a display screen of the output means, and placing the specified information at appropriate positions of the tree diagram; (c) prompting and receiving identifiable information of the case related to proof of facts for the case, including the obtained evidence obtained, the needed evidence, the rules of law affecting the proof of the case and the points of law that are disputed, and placing the identified information at appropriate positions of the tree diagram in correct correlation with the specified information; (d) computing estimations to assist the user in evaluation of the case, including estimations on the strength of each evidence, on the strength of a desired inference from each evidence, on how much it will cost to secure needed evidence, and on a likely resolution of the disputed points of law; and (e) establishing the logical relationships among the specified information and identified information.

Defined more broadly, the present invention is a method of providing litigation management and support by utilizing a computer system with adequate computing power and memory and data storage capacity and means for input and output, the method comprising the steps of: (a) executing a program on the computer that prompts a user to input necessary specifiable information of a case through the input means; (b) producing a visual diagram through the output means that allows the user to place the specified information at appropriate positions of the diagram; (c) prompting and receiving identifiable information of the case related to proof of facts for the case and placing the identified information at appropriate positions of the diagram in correct correlation with the specified information; (d) computing estimations to assist the user in evaluation of the case; and (e) establishing the logical relationships among the specified information and the identified information.

Of course the present invention is not intended to be restricted to any particular form or arrangement, or any specific embodiment, or any specific use, disclosed herein, since the same may be modified in various particulars or relations without departing from the spirit or scope of the claimed invention hereinabove shown and described of which the method shown is intended only for illustration and disclosure of an operative embodiment and not to show all of the various forms or modifications in which this invention might be embodied.

The present invention has been described in considerable detail in order to comply with the patent laws by providing full public disclosure of at least one of its forms. However, such detailed description is not intended in any way to limit the broad features or principles of the present invention, or the scope of the patent to be granted. Therefore, the invention is to be limited only by the scope of the appended claims.

What is claimed is:

1. A method of providing litigation management and support by utilizing a computer system with adequate computing power and memory and data storage capacity and means for input and output, the method comprising the steps of:
a. executing a program on said computer that prompts a user to input necessary specifiable information of a case through said input means, including the parties to the case, the claims and defenses, and the elements of each claim and defense;
b. producing a visual “tree” diagram through a display screen of said output means, and placing said specified information at appropriate positions of said tree diagram;
c. prompting and receiving identifiable information of said case related to proof of facts for said case, including the obtained evidence obtained, the needed evidence, the rules of law affecting the proof of the case and the points of law that are disputed, and placing the identified information at appropriate positions of said tree diagram in correct correlation with said specified information;
d. computing estimations to assist the user in evaluation of the case, including an estimation on the strength of each evidence, an estimation on the strength of a desired inference from each evidence, an estimation on how much it will cost to secure needed evidence, and an estimation on a likely resolution of said disputed points of law; and
e. establishing the logical relationships among said specified information and said identified information.

2. The method in accordance with claim 1, further comprising the step of generating a “to-do” list for the tasks to be performed in said case.

3. A method of providing litigation management and support by utilizing a computer system with adequate computing power and memory and data storage capacity and means for input and output, the method comprising the steps of:
a. executing a program on said computer that prompts a user to input necessary specifiable information of a case through said input means;
b. producing a visual diagram through said output means that allows the user to place the specified information at appropriate positions of said diagram, further comprising the steps of:
I. specifying the parties in said case;
ii. specifying the claims and defenses in said case;
iii. specifying the elements of said claim or defense in said case;
c. prompting and receiving identifiable information of said case related to proof of facts for said case and placing the identified information at appropriate positions of said diagram in correct correlation with said specified information, further comprising the steps of:
I. identifying what evidence has been secured;
ii. identifying what evidence needs to be secured;
iii. identifying what rules of law affect the proof of said case;
iv. identifying what points of law are disputed;
d. computing estimations to assist the user in evaluation of the case, including an estimation on the strength of each evidence, an estimation on the strength of a desired inference from each evidence, an estimation on how much it will cost to secure needed evidence, and an estimation on a likely resolution of said disputed points of law; and
e. establishing the logical relationships among said specified information and said identified information.

4. The method in accordance with claim 3, further comprising the step of generating a “to-do” list for the tasks to be performed in said case.

5. A method of providing litigation management and support by utilizing a computer system with adequate computing power and memory and data storage capacity and means for input and output, the method comprising the steps of:
a. executing a program on said computer that prompts a user to input necessary specifiable information of a case through said input means;
b. producing a visual diagram through said output means that allows the user to place the specified information at appropriate positions of said diagram;
c. prompting and receiving identifiable information of said case related to proof of facts for said case and placing the identified information at appropriate positions of said diagram in correct correlation with said specified information;
d. computing estimations to assist the user in evaluation of the case; and
e. establishing the logical relationships among said specified information and said identified information.

6. The method in accordance with claim 5, wherein said step (a) further comprises the step of specifying the parties in said case.

7. The method in accordance with claim 5, wherein said step (a) further comprises the step of specifying the claims and defenses in said case.

8. The method in accordance with claim 7, further comprising the step of specifying the elements of a particular claim or defense in said case.

9. The method in accordance with claim 5, wherein said step (c) further comprises the step of identifying what evidence has been secured.

10. The method in accordance with claim 9, further comprising the step of identifying what evidence needs to be secured.

11. The method in accordance with claim 5, wherein said step (c) further comprises the step of identifying what rules of law affect the proof of said case.

12. The method in accordance with claim 5, wherein said step (c) further comprises the step of identifying what points of law are disputed.

13. The method in accordance with claim 5, wherein said estimations include an estimation on the strength of each evidence.

14. The method in accordance with claim 5, wherein said estimations include an estimation on the strength of a desired inference from each evidence.

15. The method in accordance with claim 10, wherein said estimations include an estimation on how much it will cost to secure needed evidence.

16. The method in accordance with claim 12, wherein said estimations include an estimation on a likely resolution of said disputed points of law.

17. The method in accordance with claim 5, further comprising the step of generating a “to-do” list for the tasks to be performed in said case.
